(19) United States
(12) Patent Application Publication
(10) Pub. No.: US 2024/0413988 A1
(43) Pub. Date: Dec. 12, 2024

(54) MULTI-FACTOR AUTHENTICATION HARDENING

(71) Applicant: INTERNATIONAL BUSINESS MACHINES CORPORATION, ARMONK, NY (US)

(72) Inventors: Mark Duane Seaborn, Algonquin, IL (US); Raghuraman Kalyanaraman, Round Rock, TX (US); Asimuddin Kazi, Naperville, IL (US)

(21) Appl. No.: 18/331,976

(22) Filed: Jun. 9, 2023

(51) Int. Cl. H04L 9/08; H04L 9/30; H04L 9/32

(52) U.S. Cl. CPC H04L 9/088; H04L 9/30; H04L 9/3263

(57) ABSTRACT

Described are techniques for a multi-factor authentication (MFA) protocol that encrypts a factor using a public key of an identity certificate issued to a user. The techniques include receiving a request for a factor of an MFA protocol from a user-device. The techniques further include generating an encrypted factor using a public key of an identity certificate issued to a user of the user-device. The techniques further include sending the encrypted factor to the user-device to allow the user-device to obtain the factor by decrypting the encrypted factor using a private key that corresponds to the public key. The techniques further include receiving the factor from the user-device and verifying that the factor received from the user-device is a same factor used to generate the encrypted factor.

### BACKGROUND

The present disclosure relates to authentication, and, more specifically, to multi-factor authentication.

Multi-factor authentication (MFA), which includes two-factor authentication (2FA), comprises an electronic authentication method in which a user is granted access to a resource (e.g., a website, application, database, etc.) after successfully presenting two or more pieces of evidence or factors to an authentication mechanism. Factors presented by a user can include: knowledge (something the user knows), possession (something the user has), or inherence (something the user is). MFA protects data, such as personally identifiable information (PII) and financial assets, from being accessed by unauthorized persons or entities who may have discovered a first-factor authentication credential, such as a username and password.

### SUMMARY

Aspects of the present disclosure are directed toward a computer-implemented method comprising receiving a request for a factor of a multi-factor authentication (MFA) protocol from a user-device. The computer-implemented method further comprising generating an encrypted factor using a public key of an identity certificate issued to a user of the user-device. The computer-implemented method further comprising sending the encrypted factor to the user-device to allow the user-device to obtain the factor by decrypting the encrypted factor using a private key that corresponds to the public key. The computer-implemented method further comprising receiving the factor from the user-device and verifying that the factor received from the user-device is a same factor used to generate the encrypted factor.

Additional aspects of the present disclosure are directed to systems and computer program products configured to perform the methods described above. The present summary is not intended to illustrate each aspect of, every implementation of, and/or every embodiment of the present disclosure.

### BRIEF DESCRIPTION OF THE DRAWINGS

The drawings included in the present application are incorporated into and form part of the specification. They illustrate embodiments of the present disclosure and, along with the description, serve to explain the principles of the disclosure. The drawings are only illustrative of certain embodiments and do not limit the disclosure.

FIG. 1 is a block diagram illustrating example components that implement techniques for hardening a factor of a multi-factor authentication protocol, in accordance with some embodiments of the present disclosure.

FIG. 2 is a sequence diagram that illustrates an example method for issuing an identity certificate to a user for use in multi-factor authentication, in accordance with some embodiments of the present disclosure.

FIG. 3 is a sequence diagram that illustrates an example method for a multi-factor authentication protocol that encrypts a second-factor using a public key of an identity certificate issued to a user, in accordance with some embodiments of the present disclosure.

FIG. 4 is a flow diagram illustrating an example method for a multi-factor authentication protocol, in accordance with some embodiments of the present disclosure.

FIG. 5 is a block diagram that illustrates an example computing environment in which aspects of the present disclosure can be implemented, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure are directed toward a multi-factor authentication (MFA) protocol that encrypts a factor using a public key of an identity certificate issued to a user. While not limited to such applications, embodiments of the present disclosure may be better understood in light of the aforementioned context.

Authentication allows user-access to a computer resource, such as a network, device, or application. Generally, an authentication protocol requests that a user supply an identity by which the user is known to the computer resource, along with evidence of the authenticity of the user's claim to that identity. Simple authentication requests that a user provide one piece of evidence or factor, typically a password. For additional security, an authentication protocol can request more than one factor. The use of multiple authentication factors to prove one's identity is based on the premise that an unauthorized actor is unlikely to be able to supply the factors required for access. If, in an authentication attempt, at least one of the components is missing or supplied incorrectly, the user's identity is not established with sufficient certainty to allow access to a computing resource.

MFA works well in certain circumstances. However, there are some vulnerabilities that attackers can leverage to defeat MFA. One type of vulnerability of MFA that utilizes a one-time password or pin (OTP) as a factor (e.g., a second-factor) are subscriber identity module (SIM) swap attacks. A SIM swap attack is a type of fraud in which a mobile phone carrier is tricked into transferring a user's phone number to a SIM card controlled by an attacker, who can then utilize the user's phone number to receive an OTP intended for the user and gain access to the user's account. Another type of vulnerability are phishing attacks, which are a type of social engineering attack in which an attacker sends a fraudulent text message or email that appears to be from a legitimate source. The goal of a phishing attack is to trick the user into revealing their personal information, including an OTP used as a factor of MFA. If the user falls for the phishing attack, the attacker can use the OTP to gain unauthorized access to the user's account.

Advantageously, aspects of the present disclosure address MFA vulnerabilities like those described above by hardening a factor of an MFA protocol. More specifically, aspects of the present disclosure issue an identity certificate to a user of a user-device after successful vetting of the user. Thereafter, the user provides the identity certificate to a provider of a protected electronic resource (e.g., website, network, application, database, etc.) for use in generating an encrypted factor of an MFA protocol that grants the user access to the electronic resource upon successful authentication of the user. As a non-limiting example, after authenticating a first-factor of an MFA (e.g., a username and password), the provider generates an encrypted second-factor using a public key of the user's identity certificate. The provider then sends the encrypted second-factor to a user-device associated with the user, which in response, decrypts the encrypted second-factor utilizing the user's corresponding private key. The user (via the user-device) then sends the decrypted second-factor to the provider which, in response to receiving the decrypted second-factor, authenticates the second-factor.

The aspects of the present disclosure described above provide improvements in the area of MFA. More specifically, aspects of the present disclosure address the challenge of verifying that a person submitting a factor for verification using MFA is the legitimate account owner and not an attacker. Moreover, the elements of: generating an encrypted factor using a public key of an identity certificate issued to a user of a user-device, and sending the encrypted factor to the user-device to allow the user to obtain the factor by decrypting the encrypted factor utilizing the use's corresponding private key, and thereafter, authenticating the user in response to receiving the decrypted factor from the user-device, are a practical application that improves over other technologies in the field of MFA.

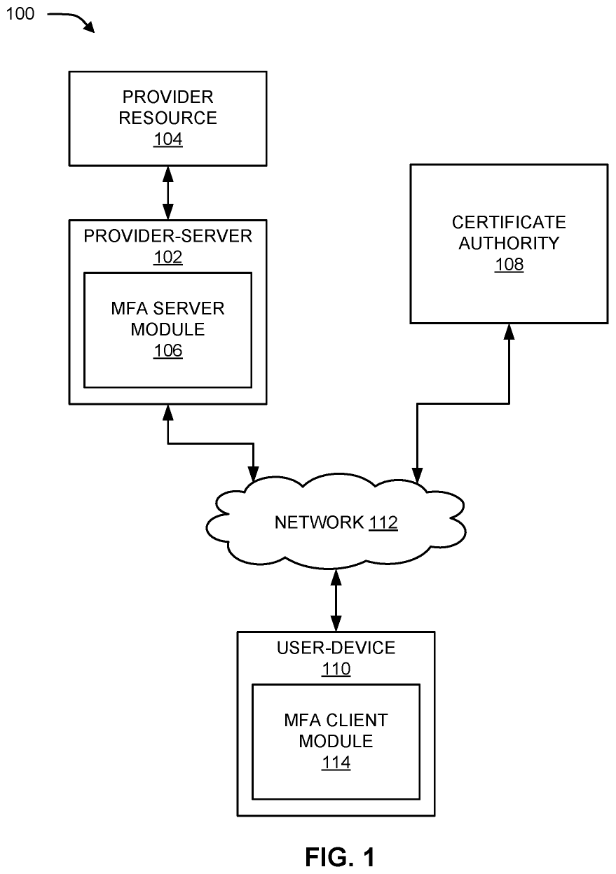

Referring now to the figures, FIG. 1 illustrates a block diagram of example components 100 used to implement techniques for hardening a factor of an MFA protocol, in accordance with some embodiments of the present disclosure. As illustrated, the components 100 can include a provider-server 102 that is in network communication with a user-device 110. A provider-server 102 can be associated with an entity that provides a protected electronic resource (provider resource 104) to customers. A provider-server 102 acts as a gateway to a provider resource 104. A provider resource 104 can comprise an electronic resource (e.g., website, network, application, database, etc.) that is accessible via a network 112 and is protected from unauthorized access using an MFA protocol that hardens a factor of the MFA protocol. The factor of the MFA protocol can be any piece of information that can be encrypted using a public key and decrypted using a corresponding private key, and thereafter used to verify a user identity.

An MFA server module 106 hosted on the provider-server 102, and an MFA client module 114 hosted on a client-device 110, implement hardening of the MFA protocol to protect the provider resource 104 from unauthorized access. The MFA server module 106 manages authentication of a user by verifying two or more factors provided by the user. In particular, the MFA server module 106 hardens a factor (e.g., first-factor, second-factor, nth factor) of the MFA protocol using encryption. The factor is encrypted using a public key of an identity certificate issued to a user.

In some embodiments, a user obtains an identity certificate for use of the MFA protocol from a certificate authority 108. The certificate authority 108 verifies the identity of the user (e.g., using personally identifying information provided to the certificate authority) and issues the identity certificate to the user. The identity certificate, also referred to as a public key certificate or digital certificate, is an electronic file that binds a public key with a private key owned (created) by a user. As background, X.509 is an International Telecommunication Union (ITU) standard defining the format of public key certificates. X.509 certificates are used in many Internet protocols and offline applications, like electronic signatures. An X.509 certificate binds an identity to a public key using a digital signature. An X.509 certificate contains an identity (a hostname, or an organization, or an individual) and a public key (e.g., RSA, digital signature algorithm (DSA), elliptic curve digital signature algorithm (ECDSA), etc.), and is either signed by a certificate authority or is self-signed. When an X.509 certificate is signed by a trusted certificate authority, or validated by other means, a party holding the certificate can use the public key it contains to establish secure communications with another party, or validate documents digitally signed by the corresponding private key. Alternatively, in some embodiments, a user obtains an identity certificate from a provider who is equipped to issue identity certificates to their customers. The provider verifies the identity of the user (e.g., using personally identifying information provided to the provider) and issues the identity certificate to the user for use in performing MFA with the provider.

As described above, an identity certificate binds a user's identity (private key) to a public key. In public-key cryptography, or asymmetric cryptography, pairs of related keys are used to encrypt and decrypt data. A key pair includes a public key and a corresponding private key. The private key is uniquely associated with an owner and is not made public. The corresponding public key can be provided to any entity with whom the private key owner wishes to communicate. An entity provided with the public key can encrypt data using the public key, and the owner of the corresponding private key can decrypt the data using the private key. In other words, the public key locks up the data from unauthorized use, and the private key is used by the owner to unlock the data. The public key can also be used to verify a digital signature created using the corresponding private key.

After obtaining an identity certificate from one of a certificate authority 108 or provider, a user makes their identity certificate available to the MFA server module 106 for use in performing the MFA protocol. In embodiments where a user obtains an identity certificate from a certificate authority 108, a provider can obtain the identity certificate from the certificate authority 108 that issued the identity certificate. In embodiments where a provider issues identity certificates to users, the provider maintains the identity certificates using the provider's resources.

After obtaining an identify certificate as described above, the user (via the user-device 110) can now request access to a provider resource 104 using the MFA protocol. In some embodiments, as part of performing the MFA protocol, the MFA server module 106 generates (or obtains) a factor, which can be a first factor, a second factor, or an nth factor of the MFA protocol, and the MFA server module 106 encrypts the factor using the public key contained in the user's identity certificate. Thereafter, the MFA server module 106 sends the encrypted factor to the MFA client module 114 hosted on the user-device 110. The MFA client module 114 can comprise a provider application (e.g., a mobile app) that has been installed on the user-device 110, a browser extension installed on a browser application, and the like.

In response to receiving an encrypted factor, the MFA client module 114 decrypts the factor utilizing the user's corresponding private key, and submits the decrypted factor to the MFA server module 106 for verification. Because the MFA server module 106 has the factor (e.g., the MFA server module 106 temporarily stores the unencrypted factor in memory), the MFA server module 106 is able to verify that the factor submitted by the MFA client module 114 is the same factor sent to the user-device 110 by the MFA server module 106. As an example, in the context of two-factor authentication (2FA) used to grant access to a provider resource 104, the MFA protocol starts with the MFA server module 106 authenticating a first-factor (e.g., password) submitted by the user. If the first-factor is authenticated, then the MFA server module 106 generates a second-factor, such as a one-time password, and encrypts the second-factor using a public key obtained from the user's identity certificate. The MFA server module 106 then sends the encrypted second-factor to the MFA client module 114 hosted on the user-device 110. In response to receiving the encrypted second-factor, the MFA client module 114 decrypts the second-factor using the user's corresponding private key, and submits the decrypted second-factor to the MFA server module 106 hosted on the provider-server 102. If the second-factor received from the user-device 110 is verified by the MFA server module 106, then the user-device 110 is granted access to the provider resource 104.

In some embodiments, the MFA protocol can further comprise verifying that a factor, returned to a provider by a user (via a user-device 110), originated from a user-device 110 associated with the user. More specifically, the user-device 110 can sign the factor using the user's private key before returning the factor to the MFA server module 106. For example, in response to receiving an encrypted factor from the MFA server module 106, the MFA client module 114 hosted on the user-device 110 decrypts the encrypted factor and then signs the decrypted factor utilizing the user's private key. As background, placing a digital signature on a factor (e.g., an object) utilizing a user's private key adds an encrypted mathematical summary of the factor; and a recipient (e.g., a provider) of the signed factor can verify the identity of the user by verifying the authenticity of the signature utilizing the user's public key. After signing the decrypted factor, the MFA client module 114 submits the signed factor to the MFA server module 106 hosted on the provider-server 102. Although the factor is not encrypted, the summary itself is encrypted to prevent unauthorized changes to the summary. Thus, when received, the MFA server module 106 can ensure that the factor originated from the user-device 110 by validating the signature using the public key in the user's identity certificate, which provides an additional level of assurance that the provider is communicating with the user.

In some embodiments, the MFA server module 106 and/or the MFA client module 114 can be implemented as a computing service hosted in a computing service environment. For example, a module can be considered a service with one or more processes executing on a server or other computer hardware. Such services can provide a service application that receives requests and provides output to other services or consumer devices. An API can be provided for each module to enable a first module to send requests to and receive output from a second module.

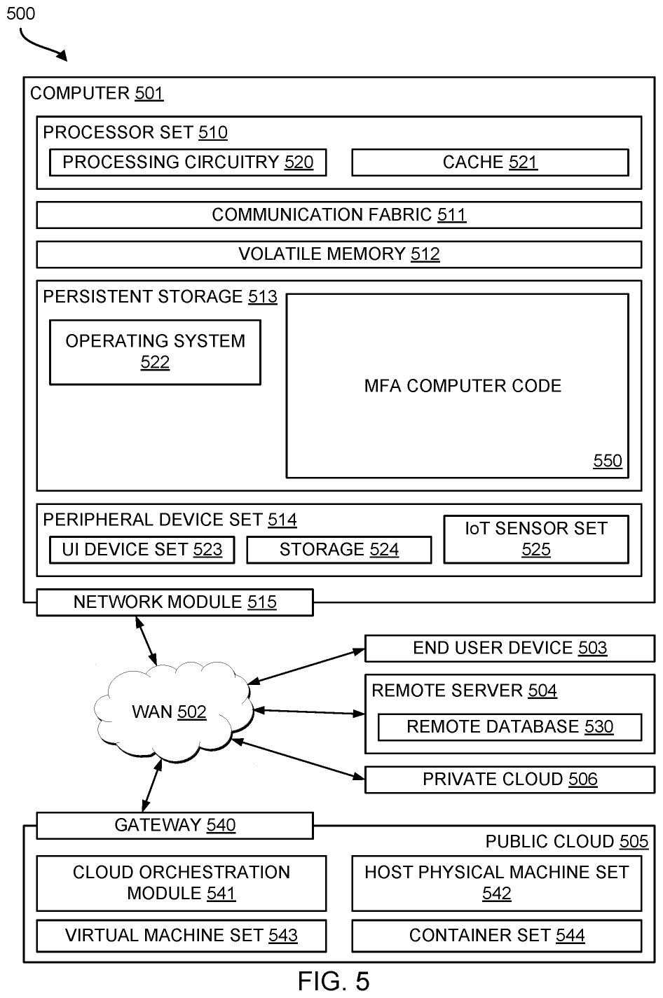

All or a portion of the components 100 shown in FIG. 1 can be implemented, for example by all or a subset of the computing environment 500 shown in FIG. 5. Further, the MFA server module 106 and/or the MFA client module 114 can be implemented in software, hardware, firmware or a combination thereof. When software is used, the operations performed by the MFA server module 106 and the MFA client module 114 can be implemented in program instructions configured to run on hardware, such as a processor unit. When firmware is used, the operations can be implemented in program instructions and data and stored in persistent memory to run on a processor unit. When hardware is employed, the hardware can include circuits that operate to perform the operations.

FIG. 1 illustrates that a network 112 is provided to enable communication between the components 100. The network 112 can include any useful computing network, including an intranet, the Internet, a local area network, a wide area network, a wireless data network, or any other such network or combination thereof. Components utilized for the network 112 can depend at least in part upon the type of network and/or environment selected. Communication over the network 112 can be enabled by wired or wireless connections and combinations thereof.

While FIG. 1 illustrates an example computational environment that can implement the techniques above, many other similar or different environments are possible. For example, other components in addition to, or in place of, the ones illustrated can be used. Some components may be unnecessary. Also, the blocks are presented to illustrate some functional components. One or more of these blocks can be combined, divided, or combined and divided into different blocks when implemented in an illustrative embodiment.

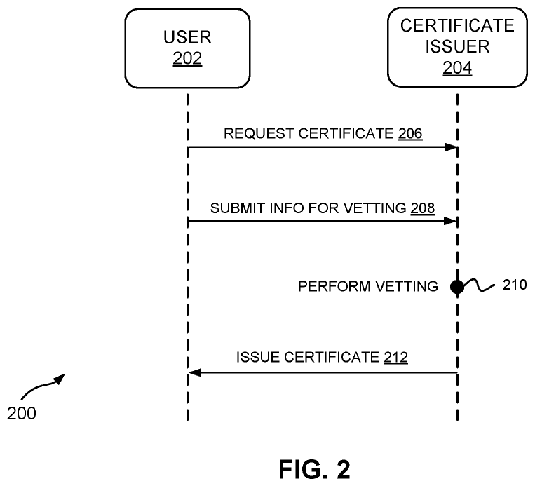

FIG. 2 illustrates an example method 200 for issuing an identity certificate to a user 202 for use in MFA, in accordance with some embodiments of the present disclosure. The user 202 who wants to utilize the MFA protocol described herein can obtain an identity certificate for use in encrypting a hardening a factor of the MFA protocol.

In operation 206, a user 202 requests an identity certificate from a certificate issuer 204. In some embodiments, a certificate issuer 204 is a certificate authority, which stores, signs, and issues identity certificates that certify the ownership of a public key by the named subject (a user 202) of the identity certificate. The certificate authority acts as a third party who is trusted by both by the subject (user 202) of the identity certificate and by a party (provider) relying upon the identity certificate. In other embodiments, a user 202 can obtain an identity certificate from a provider who is equipped to issue identity certificates to their customers.

In operation 208, as part of requesting an identity certificate, the user 202 submits information (e.g., personally identifying information) to the certificate issuer 204 that can be used to verify the identity of the user 202. Alternatively, or in addition to, the certificate issuer 204 can meet with (interview) the user 202 to verify the identity of the user 202. For example, in the case that a provider (e.g., a financial institution) is the certificate issuer 204, the user 202 (e.g., customer) can meet with or speak to a provider representative who can verify the identity of the user 202.

In operation 210, the certificate issuer 204 verifies the identity of the user 202 using the information submitted by the user 202 (e.g., checking the user's references, education, work history, credit history and/or conducting a criminal background). In operation 212, after verifying the identity of the user 202, the certificate issuer 204 generates an identity certificate and issues the identity certificate to the user 202 for use in hardening a factor of the MFA protocol.

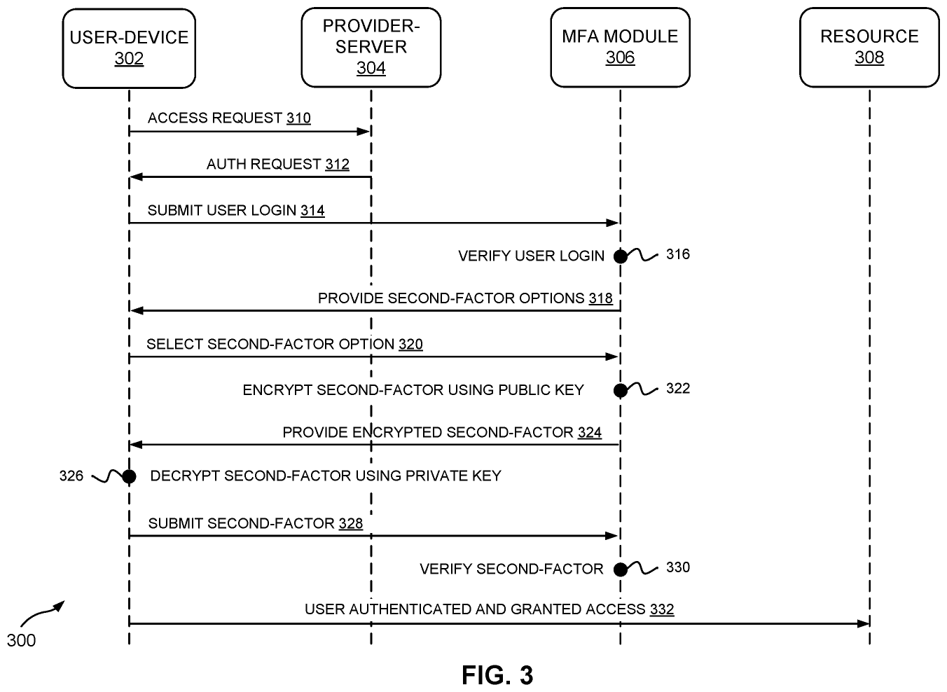

FIG. 3 illustrates an example method 300 for an MFA protocol that encrypts a second-factor using a public key of an identity certificate issued to a user, in accordance with some embodiments of the present disclosure. More specifically, FIG. 3 illustrates an example of encrypting the second-factor of a 2FA using the public key associated with the user.

In operation 310, the user (via a user-device 302) sends a request to access a resource 308 (e.g., website, network, application, database, etc.) to a provider-server 304. In response, the provider-server 304 sends an authentication request back to the user-device 302, as in operation 312, requesting that the user provide evidence (a factor) that the user is authorized to access the resource 308. In particular, the provider-server 304 requests that the user provide a first-factor comprising a user login (e.g., username and password). In operation 314, the user (via the user-device 302) submits their user login to an MFA module 306 (via the provider-server 304), and in operation 316, the MFA module 306 verifies that the user login is correct.

After verifying the first-factor of the 2FA protocol, the MFA module 306, in operation 318, provides the user with one or more options for receiving the second-factor. The options for receiving the second-factor can include email, text message, in-app message (a message delivered to a user while they are directly active in a provider's mobile application), or any other communication channel that is capable of delivering an encrypted second-factor.

In operation 320, the user selects an option (communication channel) for receiving the second-factor, and in response, the MFA module 306 obtains the second-factor (e.g., a one-time password); obtains the user's public key from the user's identity certificate; and encrypts the second-factor using the public key, as in operation 322. In some embodiments, the MFA module 306 obtains the user's identity certificate using the login information provided by the user as the first-factor (e.g., a username provided by the user can be used to identify the user's identity certificate). In other embodiments, a device identifier (e.g., Internet Protocol (IP) address, media access control (MAC) address, an international mobile equipment identity (IMEI), or the like) can be used by the MFA module 306 to obtain the user's identity certificate.

In operation 324, the MFA module 306 sends the encrypted second-factor to the user-device 302 using the option (communication channel) selected by the user. In operation 326, the user-device 302 decrypts the encrypted second-factor using the corresponding private key and, in operation 328, the user-device 302 submits the decrypted second-factor to the MFA module 306 (via the provider-server 304). In operation 330, the MFA module 306 verifies that the decrypted second-factor received from the user-device 302 matches the second-factor that the MFA module 306 first encrypted and then sent to the user-device 302.

Returning to operation 328, in some embodiments, as part of submitting the decrypted second-factor to the MFA module 306, the user-device 302 signs the decrypted second-factor using the user's private key. In response to receiving the signed decrypted second-factor, the MFA module 306 verifies the signature using the corresponding public key, thereby verifying that the decrypted second-factor was sent by the user. In operation 332, verifying the first-factor and the second-factor of the 2FA protocol authenticates the identity of the user and grants the user access to the resource 308.

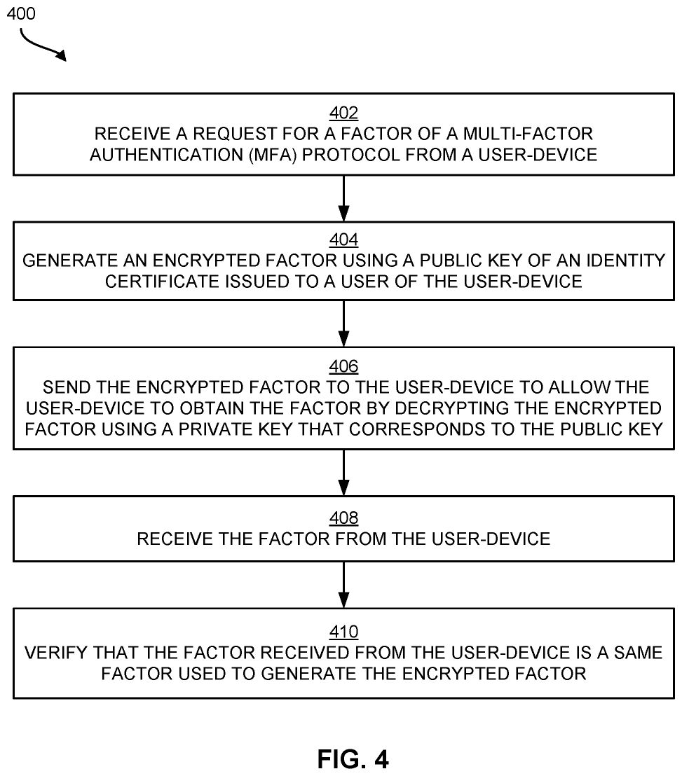

FIG. 4 is a flow diagram illustrating an example method 400 for an MFA protocol that encrypts a factor using a public key of an identity certificate issued to a user. Starting in operation 402, the method 400 receives a request for a factor of the MFA protocol from a user-device. In some embodiments, the factor is a second-factor of a 2FA protocol. Also, in some embodiments, the request for the factor includes a selection of a communication channel (e.g., email, text message, etc.) for sending the factor to the user-device. For example, a user of the user-device can be provided with a plurality of options for receiving the factor, which when selected, generates the request for the factor.

In operation 404, the method 400 generates an encrypted factor using a public key of an identity certificate issued to a user of the user-device. In some embodiments, the identity certificate is issued to the user by a certificate authority after successful vetting of the user. In other embodiments, the identity certificate is issued to the user by a provider after successful vetting of the user.

In operation 406, the method 400 sends the encrypted factor to the user-device to allow the user-device to obtain the factor by decrypting the encrypted factor using a private key that corresponds to the public key. In operation 408, the method 400 receives the factor from the user-device, and in operation 410, the method 400 verifies that the factor received from the user-device is a same factor used to generate the encrypted factor. In some embodiments, verifying the factor includes verifying a signature included with the factor using the public key of the identity certificate. For example, the user-device signs the factor using a private key that corresponds to the public key, and the user-device provides the signed factor for verification of both the signature and the factor. The method 400 described above can be performed by a computer (e.g., computer 501 in FIG. 5), performed in a cloud environment (e.g., clouds 506 or 505 in FIG. 5), and/or generally can be implemented in fixed-functionality hardware, configurable logic, logic instructions, etc., or any combination thereof.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 500 contains an example of an environment for the execution of at least some of the computer code involved in performing the disclosed methods, such as block 550 containing computer code for an MFA protocol that encrypts a factor using a public key of an identity certificate issued to a user. In addition to block 550, computing environment 500 includes, for example, computer 501, wide area network (WAN) 502, end user-device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and block 550, as identified above), peripheral device set 514 (including user interface (UI), device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 521 and the other storage media discussed below. The computer readable program instructions, and associated data, are accessed by processor set 510 to control and direct performance of the disclosed methods. In computing environment 500, at least some of the instructions for performing the disclosed methods may be stored in block 550 in persistent storage 513.

COMMUNICATION FABRIC 511 is the signal conduction paths that allow the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, the volatile memory is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid-state storage devices. Operating system 522 may take several forms, such as various known proprietary operating systems or open-source Portable Operating System Interface type operating systems that employ a kernel. The code included in block 550 typically includes at least some of the computer code involved in performing the disclosed methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the disclosed methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER-DEVICE (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. The terms “comprises,” “comprising,” “includes,” “including,” “has,” “having,” “contains” or “containing,” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus. The term “user” refers to an entity (e.g., an individual(s), a computer, or an application executing on a computer). It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof.

In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding the various embodiments. But the various embodiments can be practiced without these specific details. In other instances, well-known circuits, structures, and techniques have not been shown in detail in order not to obscure embodiments.

Different instances of the word “embodiment” as used within this specification do not necessarily refer to the same embodiment, but they can. Any data and data structures illustrated or described herein are examples only, and in other embodiments, different amounts of data, types of data, fields, numbers and types of fields, field names, numbers and types of rows, records, entries, or organizations of data can be used. In addition, any data can be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

Any advantages discussed in the present disclosure are example advantages, and embodiments of the present disclosure can exist that realize all, some, or none of any of the discussed advantages while remaining within the spirit and scope of the present disclosure.

What is claimed is:

1. A computer-implemented method comprising:
receiving a request for a factor of a multi-factor authentication (MFA) protocol from a user-device;
generating an encrypted factor using a public key of an identity certificate issued to a user of the user-device;
sending the encrypted factor to the user-device to allow the user-device to obtain the factor by decrypting the encrypted factor using a private key that corresponds to the public key;
receiving the factor from the user-device; and
verifying that the factor received from the user-device is a same factor used to generate the encrypted factor.

2. The computer-implemented method of claim 1, wherein the factor is a second-factor of a two-factor authentication (2FA) protocol.

3. The computer-implemented method of claim 1, wherein verifying the factor received from the user-device further comprises:
verifying a signature included with the factor using the public key of the identity certificate, wherein the user-device signs the factor using the private key.

4. The computer-implemented method of claim 1, wherein receiving the request for the factor further comprises:
in response to verifying a user login, providing the user of the user-device with a plurality of options for receiving the factor, which when selected, generates the request for the factor.

5. The computer-implemented method of claim 1, wherein receiving the request for the factor further comprises:
receiving, from the user-device, a selected communication channel for sending the factor to the user-device.

6. The computer-implemented method of claim 1, wherein the identity certificate is issued to the user by a provider after successful vetting of the user.

7. The computer-implemented method of claim 1, wherein the identity certificate is issued to the user by a certificate authority after successful vetting of the user.

8. A system comprising:
one or more computer readable storage media storing program instructions and one or more processors which, in response to executing the program instructions, are configured to:
receive a request for a factor of a multi-factor authentication (MFA) protocol from a user-device;
generate an encrypted factor using a public key of an identity certificate issued to a user of the user-device;
send the encrypted factor to the user-device to allow the user-device to obtain the factor by decrypting the encrypted factor using a private key that corresponds to the public key;
receive the factor from the user-device; and
verify that the factor received from the user-device is a same factor used to generate the encrypted factor.

9. The system of claim 8, wherein the factor is a second-factor of a two-factor authentication (2FA) protocol.

10. The system of claim 8, wherein the program instructions configured to cause the one or more processors to verify the factor received from the user-device are further configured to cause the one or more processors to:
verify a signature included with the factor using the public key of the identity certificate, wherein the user-device signs the factor using the private key.

11. The system of claim 8, wherein the program instructions configured to cause the one or more processors to receive the request for the factor are further configured to cause the one or more processors to:
provide the user of the user-device with a plurality of options for receiving the factor, which when selected, generates the request for the factor.

12. The system of claim 8, wherein the program instructions configured to cause the one or more processors to receive the request for the factor of the MFA protocol are further configured to cause the one or more processors to:
receive, from the user-device, a selected communication channel for sending the factor to the user-device.

13. The system of claim 8, wherein the identity certificate is issued to the user by a provider after successful vetting of the user.

14. The system of claim 8, wherein the identity certificate is issued to the user by a certificate authority after successful vetting of the user.

15. A computer program product comprising:
one or more computer readable storage media, and program instructions collectively stored on the one or more computer readable storage media, the program instructions configured to cause one or more processors to:
receive a request for a factor of a multi-factor authentication (MFA) protocol from a user-device;
generate an encrypted factor using a public key of an identity certificate issued to a user of the user-device;
send the encrypted factor to the user-device to allow the user-device to obtain the factor by decrypting the encrypted factor using a private key that corresponds to the public key;
receive the factor from the user-device; and
verify that the factor received from the user-device is a same factor used to generate the encrypted factor.

16. The computer program product of claim 15, wherein the program instructions configured to cause the one or more processors to verify the factor received from the user-device are further configured to cause the one or more processors to:
verify a signature included with the factor using the public key of the identity certificate, wherein the user-device signs the factor using the private key.

17. The computer program product of claim 15, wherein the program instructions configured to cause the one or more processors to receive the request for the factor are further configured to cause the one or more processors to:
provide the user of the user-device with a plurality of options for receiving the factor, which when selected, generates the request for the factor.

18. The computer program product of claim 15, wherein the program instructions configured to cause the one or more processors to receive the request for the factor of the MFA protocol are further configured to cause the one or more processors to:
receive, from the user-device, a selected communication channel for sending the factor to the user-device.

19. The computer program product of claim 15, wherein the identity certificate is issued to the user by a provider after successful vetting of the user.

20. The computer program product of claim 15, wherein the identity certificate is issued to the user by a certificate authority after successful vetting of the user.
